(19) United States
(12) Patent Application Publication
(10) Pub. No.: US 2014/0040482 A1
(43) Pub. Date: Feb. 6, 2014

(54) System and Method for Communicating Enterprise Information via Hybrid and Peer-to-Peer Cloud Networks

(71) Applicant: Sze Wong, Herndon, VA (US)

(72) Inventor: Sze Wong, Herndon, VA (US)

(73) Assignee: Zerion Software, Inc.

(21) Appl. No.: 13/567,251

(22) Filed: Aug. 6, 2012

(51) Int. Cl. G06F 15/16

(52) U.S. Cl. 709/227

(57) ABSTRACT

Various systems, computer program products, and methods for communicating enterprise information between a mobile device and a backend enterprise server via a cloud network are described. According to the invention, a plug server coupled between the mobile device and the cloud network may be used. In various implementations of the invention, the plug server is local to the mobile device and provides a connection to the mobile device via a short range communications link, which may include a short range wireless communications link. The plug server mimics or otherwise provides functionality of a middleware server typically found in the cloud network. The invention may be particularly useful in areas and/or times when the mobile device experiences limited connectivity to the cloud network via, for example, a cellular data network or other communication link provided by a network provider.

### FIELD OF THE INVENTION

The disclosure relates to systems, devices, and methods for interfacing mobile devices with a cloud network, and in particular to communicating enterprise information between mobile devices and the cloud network via an intermediate server.

### BACKGROUND OF THE INVENTION

Businesses (i.e., corporations, organizations, individuals, and/or other entities) routinely generate workflows and collect enterprise information as an important component of their operations. The workflows may include one or more questions to be answered and/or tasks to be performed. Enterprise information may include answers to the questions, status of the tasks to be performed, and/or other information collected by the business. For example, utility companies such as cable television providers generate work orders that inform technicians which customers require service and what service needs to be performed. Such utility companies also collect information from their technicians such as whether and when the service has been performed. Another example includes government entities that may generate lists of inspections to be performed at various building sites and collect inspection information from inspectors who conduct the inspections. Businesses may even generate survey questionnaires to elicit responses designed to understand how their customers and/or other individuals feel about a particular topic.

Conventional workflow and data collection solutions typically use paper-based documentation methods, where a technician, for example, is given a paper listing of tasks to be performed and the technician documents the performed tasks using paper forms. Other solutions include using dedicated hardware devices that are highly specific to the business organization. In other words, the dedicated hardware devices are typically hard-coded to perform specific tasks for a specific business. For example, parcel delivery services may use package tracking devices that are typically dedicated to record when a package has been delivered. Such package tracking devices could not, for example, be used to track the cable technician's workflow.

In the past, various technologies may have been used to implement various tasks, including various workflow and data collection solutions. In the 1960-1970s, a “dumb” terminal was connected to a mainframe computer. Data was entered via the terminal and stored and/or processed on the mainframe computer. Using more recent terms, the terminal is now referred to as a “thin client.” In the 1980-1990s, the early era of the “Internet,” client-server solutions became widespread. As opposed to earlier eras, the client-server solutions employed “thick clients.” The next decade (i.e., 2000-2010) brought forward “web computing,” which to some extent, reverted back to using “thin clients.” With the dawn of mobile computing upon us, again we see a change back to use of “thick clients” on the mobile platform as discussed further below.

Recent developments in mobile computing provide an opportunity to address drawbacks of existing systems. For example, smartphones, PDAs, tablet PCs, and other mobile devices enable mobile computing to handle increasingly complex tasks. Leveraging the power of these mobile devices to process forms greatly enhances an ability to collect enterprise information.

However, one problem with mobile devices is that they often experience limited connectivity (such as “spotty” or even worse, no cellular data coverage areas) for communication and/or data transfer. Limited connectivity may pose significant problems, given that forms to collect enterprise information may include large numbers of elements and/or complex interrelationships between the elements, which results in large amounts of information and/or complex combinations of information to be communicated between the mobile device and the cloud network. For example, enterprise information may include a listing of possible answer choices to questions. This listing of possible answers may include several thousand predefined options that may be selected, only a few of which may be relevant for a particular portion of the custom dynamic form being displayed. Thus, efficiently processing (e.g., receiving, updating, communicating, etc.) the possible answer choices may be problematic in areas of limited or no connectivity.

Conventional mobile computing platforms currently fail to address the problem of efficiently communicating large amounts of data to and from mobile devices that may experience limited data connectivity. These and other problems exist.

### SUMMARY OF THE INVENTION

Systems, devices, and methods that facilitate communication of enterprise information between mobile devices and cloud networks are provided.

In some implementations, when a mobile device experiences limited or no connectivity to a cloud network via a cellular network, the method may include determining whether a connection to a plug server is available. If the connection to the plug server is available, then the method may include communicating the enterprise information from and by the mobile device to the plug server. The plug server, in turn, communicates the enterprise information to the cloud network via another connection or via the cellular network.

In some implementations, a method for communicating enterprise information via a plug server may include receiving, by a plug server, a new or updated form element from a mobile device. In some implementations, the method may include communicating the new or updated form element to each of a plurality of mobile devices that is coupled to the plug server and has not received the new or updated form element. In some implementations, the method may include initiating a connection, by the plug server, to the cloud network, via for example, a middleware server, when the connection is available. In some implementations, the method may include communicating the new or updated form element to the middleware server via the connection.

In some implementations, a method for communicating enterprise information via a plug server may include receiving, by a plug server, a new or updated form element from an enterprise system. In some implementations, the method may include communicating the new or updated form element to each of a plurality of mobile devices that is coupled to the plug server and has not received the new or updated form element. In some implementations, the method may include initiating a connection, by the plug server, to each of the plurality of mobile devices within range and to which the new or updated form element is authorized.

Various implementations of the invention include a plug server that leverages advances in mobile device technology to communicate enterprise information between mobile devices and backend business computing platforms. In doing so, various implementations of the invention may be used to provide an out-of-the-box solution that is flexible and scalable to meet the data collection needs of various businesses.

In some implementations, a plug server serves as a middleware server that is local to a plurality of mobile devices and remote from other components in the cloud network. The plug server may be connected to each of the mobile devices via one or more short range, wireless networks other than a cellular network (e.g., GSM, CDMA, TDMA, etc). Such short range wireless connections include, but are not limited to, Bluetooth, WiFi, near-field communications (NFC), Soundwave or other short range wireless connection. Such short range wireless connections may also include one or more repeaters for extending a range of these connections as would be appreciated. The plug server may also be connected to the cloud network via various types of connections, including a cellular network, a hardwired network connection, or other type of connection as would be appreciated. In some implementations of the invention, when a mobile device experiences limited or no connectivity to the cloud network via its associated cellular network, the mobile device may connect to the plug server via a short range wireless connection.

In some implementations, from the perspective of the mobile device, the plug server acts in virtually all aspects as a middleware server in the cloud network except that the mobile device is coupled to the plug server via a short range wireless connection rather than being coupled to the middleware server via a cellular data network.

In some implementations, the plug server may receive a request from a mobile device to receive one or more dynamic forms. In response to the request, the plug server may identify the mobile device (i.e., the mobile device and/or user of the mobile device) to determine which of the one or more dynamic forms (i.e., the form design information used to render the custom forms) is available for download (i.e., receipt) by the mobile device. In some implementations, the plug server may notify the mobile device of the dynamic forms available for download by the mobile device. The mobile device may then download or otherwise synchronize the dynamic forms that are available at the plug server but not present at the mobile device.

In some implementations, the mobile device may communicate one or more values to the plug server, thereby reporting the collected enterprise information. In some implementations, the mobile device may communicate the one or more values on-demand (i.e., by request). In some implementations, the mobile device may communicate the one or more values whenever a short range wireless connection to the plug server is available. For example, the mobile device may collect enterprise information in an “offline” mode during periods of limited connectivity to the cellular network and then upload the collected enterprise information when subsequently connected to the plug server.

In some implementations, the one or more values are communicated between the mobile device and the plug server using a stateless communication protocol such as Hyper Text Transfer Protocol (HTTP). In some implementations, HTTPS (secure HTTP) is used. By using a stateless communication protocol, data may be communicated between the mobile device and the plug server in a highly scalable manner.

In some implementations, the plug server may communicate the enterprise information collected at the mobile device to an enterprise backend server via the cloud network. In some implementations, the enterprise information may be communicated to the enterprise backend server in a format particular to the backend server, thereby seamlessly integrating the enterprise information with the backend server.

### BRIEF DESCRIPTION OF THE DRAWINGS

FIG. 1 is a block diagram illustrating a system for communicating enterprise information from a mobile device to a cloud network via a plug server according to various implementations of the invention.

FIG. 2 is a block diagram illustrating a plug server according to various implementations of the invention.

FIG. 3 illustrates an example of a process for communicating enterprise information to/from a cloud network via a plug server, according to various implementations of the invention.

### DETAILED DESCRIPTION OF THE INVENTION

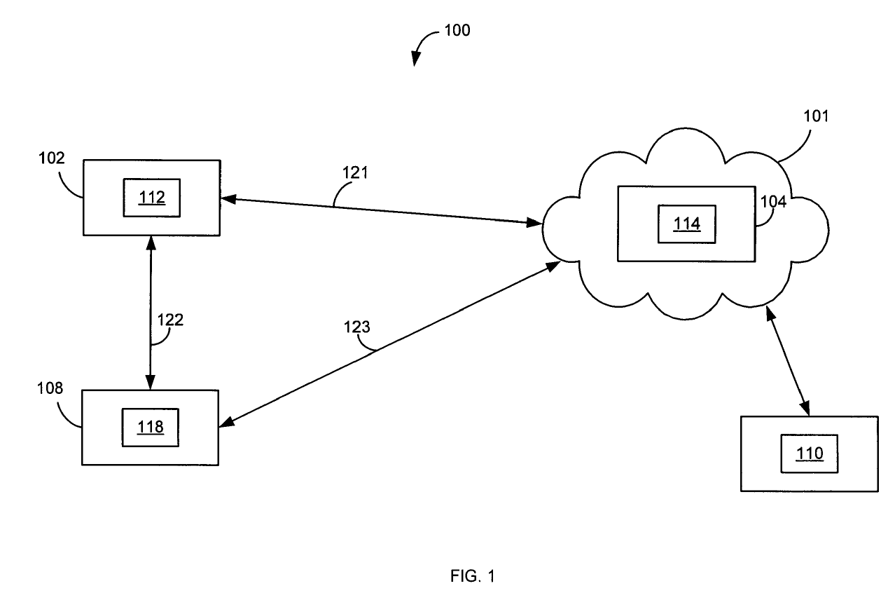

FIG. 1 is a block diagram illustrating a system 100 for communicating enterprise information between a mobile device 102 and an enterprise backend server 110 via a cloud system or network 101 according to various implementations of the invention. In FIG. 1 (as well as other drawing figures), although a single component may be illustrated, such single components may refer to multiple components unless otherwise noted. For example, although only a single middleware server 104 or mobile device 102 is illustrated, middleware server 104 may refer to a plurality of such middleware servers or mobile device 102 may refer to a plurality of such mobile devices as would be appreciated.

Mobile device 102 may be a cellular phone, a smartphone, a personal digital assistant, a tablet device, a notebook device, and/or other computing device from a wide range of manufacturers that may display dynamic forms, collect enterprise information using such dynamic forms and communicate with various other components of system 100 as would be appreciated.

Cloud network 101 includes various networks components that facilitate and implement the “cloud” and “cloud computing” as would be appreciated, including a typical middleware server 104, which may include a processing component 114.

During conventional operation, middleware server 104 in cloud network 101 may be communicably coupled to mobile device 102 via a communication link 121. In some implementations, communication link 121 may include any communication link remotely coupling mobile device 102 to middleware server 104. Such communication links may include a cellular communications network (i.e., cellular network), a satellite communications network, a wide area network, a public switched telephone network, or other wired or wireless communications network.

Generally speaking, communication link 121 typically requires access to services of a network provider such as a wireless carrier, an Internet service provider, a satellite network provider, or other network access provider to provide communications between mobile device 102 and middleware server 104 as would be appreciated. As such, communication between mobile device 102 and middleware server 104 via cloud network 101 generally requires subscription to data services provided by the network provider. For example, communication via cloud system 101 generally requires that mobile device 102 be subscribed to a cellular network provider or otherwise access a network connection provided by a network provider. From time to time, mobile device 102 may be unable to communicate via communication link 121 to cloud network 101 in areas or times of limited connectivity (i.e., low or spotty signals, insufficient signals, no signals, limited network capacity, excessive usage, etc.) or when network access is otherwise not available.

To overcome the shortcomings of communications link 121, among other reasons, various implementations of the invention employ a plug server 108. As illustrated in FIG. 1, plug server 108 may be communicably coupled to mobile device 102 via a short range communication link 122. In this configuration, plug server 122 is referred to as being local or proximate to mobile device 102, in order to accommodate communication between mobile device 102 and plug server 122 via short range communication link 122. Short range communication link 122 may comprise any one of a variety of wireless communication links including Bluetooth, near-field communications (NFC), WiFi, other IEEE 802.11 wireless communications standards, or other short range communication links employed by mobile device 102. In some implementations, such short range wireless communication links may also include one or more repeaters for extending a range of these communication links as would be appreciated. In some implementations, short range communication link may include wired links such as USB, Firewire, or removable/interchangeable memory cards for exchanging data between mobile device 102 and plug server 108. In contrast to communication link 121, communication link 122 may not require access to a third party network provider. In these implementations, when access to the services of such network provider are unavailable, mobile device 102 may communicate with (i.e., participate in) cloud network 101.

In some implementations of the invention, plug server 108 may be communicably coupled to cloud network 101 via a communications link 123. In some implementations of the invention, communications link 123 may include a type of link similar to communications link 121 and typically, though not always, requires network access via a network access provider as would be appreciated.

According to various implementations of the invention, plug server 108 comprises a relatively portable computing device that is configured to provide functions similar to middleware server 104. In some implementations, plug server 108 is configured such that a user may “plug-in” plug server 108 to a power source and access its functions, operations and communications with cloud network 101 without further manual configuration. In some implementations, plug server 108 operates without user interfaces such as keyboards or displays.

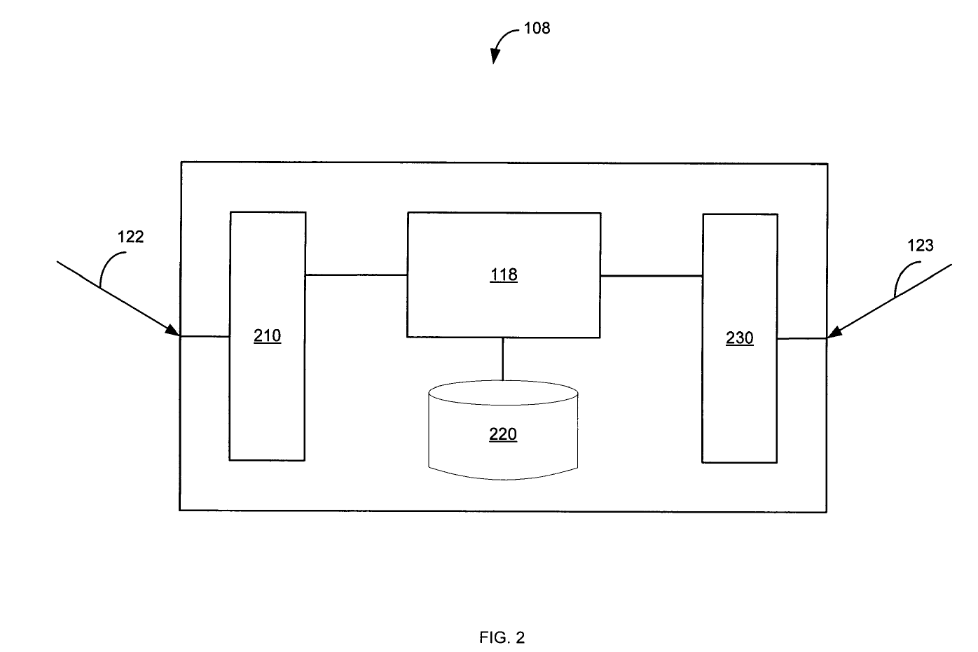

FIG. 2 illustrates various components of plug server 108 in further detail. As illustrated, plug server 108 includes a processor 118 coupled to each of a local communication port 210, a remote communication port 230, and a data store 230. Processor 118 accesses and executes various computer instructions stored on/in data store 230 that cause the processor 118 to implement various operations and functions of the invention as described herein. Processor 118 also accesses data store 230 to store and retrieve data, including forms and enterprise data as would be appreciated.

Local communication port 210 provides short range communications between processor 118 (and hence plug server 108) and mobile device 102 via short range communication link 122. Local communication port 210 comprises various hardware and/or software to implement one or more short range communications protocols as would be appreciated. In some implementations, local communications port 210 may comprise various hardware and/or software to implement one or more short range wireless communications protocols. In some implementations, local communications port 210 may comprise various hardware and/or software to implement one or more short range wired communications protocols. In some implementations, local communications port 210 may comprise various hardware and/or software to interface with one or more memory cards readable by mobile device 102.

Remote communications port 230 provides remote or long range communications between processor 118 (and hence plug server 108) and cloud network 101, including middleware server 104, and ultimately to enterprise backend server 110. Remote communication port 230 comprises various hardware and/or software to implement one or more remote communications protocols as would be appreciated. Such communications protocols include, but are not limited to WiFi, Cellular (LTE, GSM, and other 3G and 4G), WiMAX, Ethernet, Optical, and other landline and communication methods as would be appreciated.

In some implementations, plug server 108 comprises a housing within which processor 118, local communication port 210, remote communication port 230, and data store 230 are operatively coupled and housed.

In some implementations, mobile device 120 may be configured to prefer to communicate with middleware server 104 via plug server 108, if available, as opposed to directly to middleware server 104. In other words, when a connection to plug server 108 is available (i.e., via short range communications link 122) mobile device 102 communicates with cloud network 101 even if another connection is also available (i.e., via communications link 121).

In some implementations, mobile device 120 may be configured to prefer to communicate with backend server 110 via plug server 108, if available, as opposed to directly to backend server 110. In other words, when a connection to plug server 108 is available (i.e., via short range communications link 122) mobile device 102 communicates with backend server 110 even if another connection is also available (i.e., via communications link 121). In some implementations, this communication with backend server 110 may be accomplished through cloud network 101 or otherwise as would be appreciated.

As illustrated in FIG. 1, in some implementations, middleware server 104 includes a processor 114, plug server 108 includes a processor 118, and mobile device 102 includes a processor 112. According to various implementations of the invention, each of processors 112, 114, 118 may be configured interact with dynamic forms as would be appreciated, and more particularly, to design dynamic forms, communicate the dynamic forms to other components in system 100, collect enterprise information via the dynamic forms, communicate the collected enterprise information to other components in system 100 and/or perform other functions described herein or as otherwise would be appreciated. Further, functions and tasks other than interacting with dynamic forms than may be accomplished via other implementations of the invention as would be appreciated.

In some implementations, plug server 108 may receive a synchronization request from mobile device 102. The synchronization request may include a request to download information, including one or more dynamic forms, from plug server 108 to mobile device 102 in order to render one or more dynamic forms by mobile device 102, upload information from mobile device 102 to plug server 108, including one or more values collected via the one or more dynamic forms, and/or perform other synchronization functions such that plug server 108 and mobile device 102 share information that one has that the other should have. Use of dynamic forms by mobile device 102 to collect enterprise information is well understood and is not further described.

In some implementations, the synchronization operation and/or other communication of data between mobile device 102 and plug server 108, may be communicated via a stateless communication protocol. The stateless communication protocol may include HTTPS, Short Messaging Service (SMS), and/or other stateless communication protocol. In some implementations, a first portion of the data (whether synchronization data or other communication) may be communicated via a first instance of a stateless communication protocol such as a first HTTPS request and a second portion of the data may be communicated via a second instance of a stateless communication protocol such as a second HTTPS request. In this manner, using pulses of communications to transmit the first and second portions of data, communication between mobile device 102 and plug server 108 may be scaled because stateless communication protocols do not have the overhead of other communication protocols that maintain state. In other words, plug server 108 may communicate with more mobile devices 102 using stateless communication protocols than using alternative communication protocols. As would be appreciated, plug server 108 may communicate with mobile device 102 using other communication protocols when available, such as via a Wireless Internet connection, USB connection, and/or other known communication protocols that allow communication between mobile device 102 and plug server 108.

According to various implementations of the invention, at least some of the functions of middleware server 104 may be performed by plug server 108. In these implementations, plug server 108 may be configured to allow a user of mobile device 102 to design dynamic forms, receive dynamic forms, and/or collect enterprise information using the dynamic forms as well as communicate the dynamic forms and/or collected enterprise information.

In various implementations of the invention, plug server 108 sends various information to mobile device 102 via short range communications link 122. Such information includes dynamic forms, options lists and record assignments, and other information useful for collecting enterprise information as would be appreciated. In various implementations of the invention, plug server 108 receives various information from mobile device 102 via short range communications link 122. Such information includes new records including collected enterprise information as would be appreciated.

In various implementations of the invention, plug server 108 performs various administrative tasks including, but not limited to: 1) adding, editing, deleting dynamic forms and/or changing a structure of one or more dynamic forms; 2) adding, editing, deleting records; 3) adding, editing, removing users (and/or their associated device(s)) who are authorized to access plug server 108; 4) assigning dynamic forms to a particular user (and/or its associated device(s)); assigning records to a particular user (and/or its associated device(s)); and other administrative tasks.

In various implementations of the invention, plug server 108 may manage various data associated with system 100 including, but not limited to collected enterprise data, which may be stored in various formats (e.g., HTML, Map, Graphics, etc.). In various implementations of the invention, plug server 108 may export data collected/stored in one format to another format (e.g., Excel, XML, RSS, ATOM, etc.). In various implementations of the invention, plug server 108 may provide various information, including geolocation information, about mobile devices 102 coupled to plug server 108.

In various implementations of the invention, plug server 108 receives updates from cloud network 101 (which may include information from middleware server 104 or enterprise backend server 110), such updates may include updates to operating software on plug server 108, updates to a configuration of plug server 108 or its operating software, updates to dynamic forms handled by plug server 108, updates to options lists handled by plug server 108, updates to licenses used by plug server 108, updates to record assignments, or other updates as would be appreciated. In some implementations, plug server 108 sends collected enterprise information to cloud network 101 that plug server 108 received/stored from mobile device(s) 102.

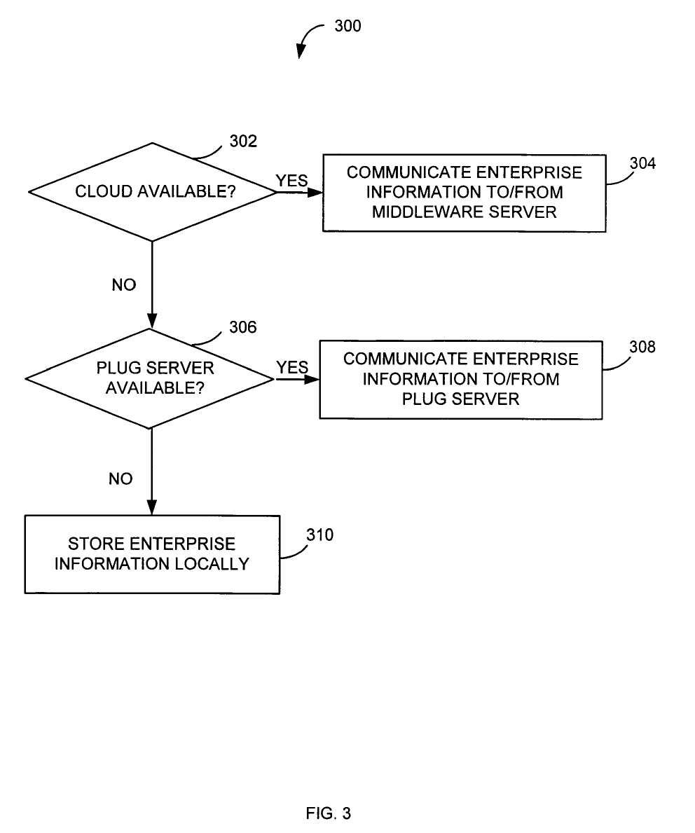

FIG. 3 illustrates an example of a process 300 for communicating enterprise information to/from mobile device 102 to cloud network 101 via plug server 108 according to various implementations of the invention.

In some implementations, in an operation 302, mobile device 102 may determine whether a connection to middleware server 104 in cloud network 101 is available. If the connection to middleware server 104 is available, then in an operation 304, mobile device 102 may communicate enterprise information to/from middleware server 104.

If in operation 302, mobile device 102 determines that the connection to middleware server 104 is not available, in an operation 306, mobile device may determine whether a connection to plug server 108 is available. If the connection to plug server 108 is available, then in operation 308, mobile device 102 may communicate the enterprise information to/from plug server 102.

As would be appreciated, in some implementations operations 302 and 304 may be interchanged such that mobile device 102 determines whether the connection to plug server 108 is available (and if so communicates the enterprise information using same) before mobile device 102 determines whether the connection to middleware server 104 is available. In some implementations of the invention, an order of determining which connection is available is configurable, either by the user, by the enterprise, or some other entity as would be appreciated.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

1. An apparatus comprising:
a processor;
a local communication port coupled to the processor and configured to provide a short range communication link to a mobile device;
a remote communication port coupled to the processor and configured to provide a long range communication link to a remote server; and
a data store coupled to the processor and configured to store instructions or data for the processor,
wherein the instructions when executed on the processor cause the processor to communicate with the mobile device via the short range communication link and to communicate with the remote server via the long range communication link.

2. The apparatus of claim 1, further comprising a housing within which the processor, the local communication port, the remote communication port, and the data store are housed.

3. The apparatus of claim 1, wherein the apparatus is local to the mobile device and remote from the remote server.

4. The apparatus of claim 1, wherein short range communication link comprises a short range wireless communication link.

5. The apparatus of claim 4, wherein short range wireless communications link comprises a link employed by mobile device.

6. The apparatus of claim 4, wherein short range wireless communications link comprises a Bluetooth communications link, a near-field communications (NFC) link, a WiFi communications link, or an IEEE 802.11 communications link.

7. The apparatus of claim 1, wherein short range communications link comprises a short range wired communications link.

8. The apparatus of claim 7, wherein short range wired communications link comprises a USB communications link, a Firewire communications link, or an interchangeable memory card.

9. The apparatus of claim 1, wherein the instructions when executed on the processor further cause the processor to replicate one or more functions of a middleware server vis-à-vis the mobile device.
